(19) United States
(12) Patent Application Publication
(10) Pub. No.: US 2026/0039514 A1
(43) Pub. Date: Feb. 5, 2026

(54) DECISION FEEDBACK EQUALIZER FOR DOUBLE DATA RATE MEMORY

(71) Applicant: Shanghai Zhaoxin Semiconductor Co., Ltd., Shanghai (CN)

(72) Inventors: Yi SHI, Beijing (CN); Qiang SI, Beijing (CN)

(21) Appl. No.: 18/964,264

(22) Filed: Nov. 29, 2024

(30) Foreign Application Priority Data
Jul. 31, 2024 (CN) 202411047494.9

(51) Int. Cl. H04L 25/03

(52) U.S. Cl. CPC H04L 25/03057

(57) ABSTRACT

A decision feedback equalizer for double data rate memory is shown, which uses a sampling circuit and an adder circuit with parallel-to-serial conversion. The sampling circuit separates the sampling of a sampling object into even bits and odd bits, to output even-bit data on an even-bit channel, and to output odd-bit data on an odd-bit channel. The adder circuit with parallel-to-serial conversion is coupled to the sampling circuit to receive the even-bit data and the odd-bit data, and to combine the even-bit data with the odd-bit data to generate full-rate data.

### CROSS REFERENCE TO RELATED APPLICATIONS

This application claims priority of China Patent Application No. 202411047494.9, filed on Jul. 31, 2024, the entirety of which is incorporated by reference herein.

### BACKGROUND OF THE INVENTION

### Field of the Invention

The present invention relates to an equalizer at the input/output (I/O) terminals of a chip, and, in particular, one application using the equalizer is a double data rate memory (DDR).

### Description of the Related Art

Central processing units (CPUs) of servers and PCs have been developed to support high-speed double data rate memory (such as the 5th generation double data rate memory DDR5, or the 5th generation low power double data rate memory LPDDR5 . . . etc., all of which are hereinafter referred to as DDR). DDR is widely used in mobile devices. DDR is fast and works in a wide bandwidth. System performance is significantly improved by using DDR. However, the input/output (I/O) design of DDR is a challenge.

The I/O terminals of DDR are usually equipped with an equalizer. Unlike typical equalization technologies such as a continuous time linear equalizer (CTLE), a decision feedback equalizer (DFE) is proposed for equalization between the I/O terminals, which does not amplify the signal noise and effectively reduces the intersymbol interference (ISI) to guarantee signal integrity.

However, a conventional analog DFE includes a heavy-loading adder. The maximum data rate of the DDR receiver, therefore, is limited. As for a conventional digital DFE, the timing of the adder circuit is tight. The critical path timing is limited to within one unit interval (1UI). The 16-nanometer process is insufficient.

How to improve the DFE speed is an important issue in the DDR field.

### BRIEF SUMMARY OF THE INVENTION

A digital decision feedback equalizer (digital DFE) is disclosed, which is used in a double data rate memory (DDR) to provide a second-order half-rate speculation capability. Such a predictive function is also called a loop unrolled technology.

The DFE includes an initialization circuit (including the adjustment based on the read-to-read turn around events), a selection circuit (operative to make DFE order selection, and even DDR mode selection), a sampling circuit, and an adder circuit with parallel-to-serial conversion. In particular, the sampling circuit is placed prior to the adder circuit, effectively increasing the time left for the critical timing path (for example, increasing from 1UI to 2UI). The DDR mode selection allows the system to support multiple DDR modes (such as DDR5 and LPDDR5). In addition, this case also introduces a special control called read-to-read turn around control, which can support a variety of read-to-read turn around events. According to the disclosure, a common process can achieve a high data rate. For example, the 16 nm process can achieve a data rate of 6400 Mbps.

A decision feedback equalizer (DFE) for a double data rate memory (DDR) in accordance with an exemplary embodiment of the disclosure a sampling circuit and an adder circuit with parallel-to-serial conversion. The sampling circuit separates the sampling of a sampling object into even bits and odd bits, to output even-bit data on an even-bit channel, and to output odd-bit data on an odd-bit channel. The adder circuit with parallel-to-serial conversion is coupled to the sampling circuit to receive the even-bit data and the odd-bit data, and to combine the even-bit data with the odd-bit data to generate full-rate data.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a decision feedback equalizer (DFE for short) 100 in accordance with an exemplary embodiment of the disclosure;

FIG. 2 is a block diagram illustrating the functional blocks in the initialization circuit 102 in accordance with an exemplary embodiment of the disclosure;

FIG. 3 illustrates the details of the initialization circuit 102 in accordance with an exemplary embodiment of the disclosure;

FIG. 4 is a block diagram illustrating the functional blocks of the selection circuit 104 in accordance with an exemplary embodiment of the disclosure;

FIG. 5 illustrates the details of the selection circuit 104 in accordance with an exemplary embodiment of the disclosure;

FIG. 6 is a block diagram, illustrating the functional blocks of the sampling circuit 106 in accordance with an exemplary embodiment of the disclosure;

FIG. 7 illustrates the details of the sampling circuit 106 in accordance with an exemplary embodiment of the disclosure;

FIG. 8 illustrates the details of the adder circuit with parallel-to-serial conversion 108 in accordance with an exemplary embodiment of the disclosure; and

FIG. 9 is a block diagram illustrating a double data rate memory (DDR) 900 in accordance with an exemplary embodiment of the disclosure.

### DETAILED DESCRIPTION OF THE INVENTION

The following description enumerates various embodiments of the disclosure, but is not intended to be limited thereto. The actual scope of the disclosure should be defined according to the claims. The various block functions mentioned below may be implemented by a combination of hardware, software, and firmware, and may also be implemented by special circuits. The various blocks and modules are not limited to being implemented separately, but can also be combined together to share certain functions.

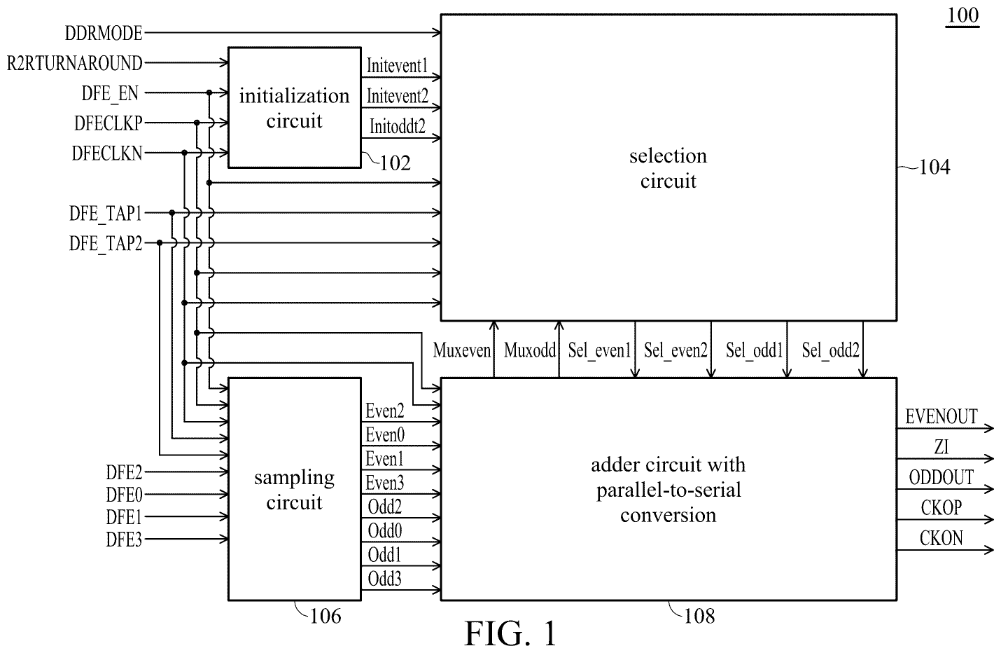

FIG. 1 is a decision feedback equalizer (DFE for short) 100 in accordance with an exemplary embodiment of the disclosure, which may be used in a DDR receiver and includes an initialization circuit 102, a selection circuit 104 (for selection of the DFE order “TAP”, or even for election of the DDR mode), a sampling circuit 106, and an adder circuit with parallel-to-serial conversion 108. All the illustrated circuits operate in the digital voltage power domain (DVDD power domain), in which the operating voltage is lower than the VPP power domain of the signals received by the DDR.

The initialization circuit 102 includes four input signals DFE_EN, DFECLKP, DFECLKN, R2RTURNAROUND, and three output signals Initevent1, Initevent2, and Initoddt2.

The signal R2RTURNAROUND is an adjustment signal for the read-to-read turn around events and comes from a logic circuit (not shown in the figure). When the sampling clocks DFECLKP and DFECLKN are continuous clocks, the signal R2RTURNAROUND is set to 1′b0. If a read-to-read turn around function is enabled, the signal R2RTURNAROUND is changed to 1′b1. The signal DFE_EN is the DFE enable signal, and is active at high level. The sampling clock DFECLKP is for rising edge sampling. The sampling clock DFECLKN is for falling edge sampling. The signals Initevent1, Initevent2, and Initoddt2 generated by the initialization circuit 102 are all transferred to the selection circuit 104 for logical calculations with the signals Muxeven and Muxodd. Accordingly, selection signals Sel_even1 and Sel_even2 are generated for the even-bit channel, and selection signals Sel_odd1 and Sel_odd2 are generated for the odd-bit channel, to control the multiplexers in the adder circuit with parallel-to-serial conversion 108.

As illustrated in FIG. 1, the selection circuit 104 receives six signals DDRMODE, DFE_EN, DFE_TAP1, DFE_TAP2, DFECLKP, and DFECLKN. The signal DDRMODE is a mode selection signal: 1′b1 supports the DDR5 protocol; and 1′b0 supports the LPDDR5 protocol. Signal DFE_TAP1 is a first-order DFE enable signal, active at high level. According to the first-order DFE, the identification of the current bit is based on the status of the previous bit. When the first-order DFE fails to provide a good eye pattern, the second-order DFE enable signal DFE_TAP2 is changed to the high level to enable the second-order DFE. According to the second-order DFE, the identification of the current bit is based on the status of the previous two bits. The ‘1’ following a long ‘0’ and the ‘0’ following a long ‘1’ will not be misjudged. After a long ‘0’, a loose threshold to judge ‘1’ is required, and a lower reference value is used to accurately identify ‘1’. After a long ‘1’, a loose threshold to judge ‘0’ is required, and a higher reference value is used to accurately identify ‘0’.

The sampling circuit 106 receives 9 input signals (DFE0, DFE1, DFE2, DFE3, DFE_EN, DFE_TAP1, DFE_TAP2, DFECLKP, DFECLKN) and generates 8 output signals (Even0 . . . Even3, and Odd0 . . . Odd3). The signals DFE0 . . . DFE3 are digital signals received and converted by the DDR receiving end, which are identified by four different reference values (Vref), and are the sampling objects of the sampling circuit 106. The first-order DFE is performed based on the signals DFE0 and DFE1. The second-order DFE is performed based on the signals DFE0, DFE1, DFE2 and DFE3. The signals DFE0 and DFE2 are sampled by the sampling clock DFECLKP, and thereby even-bit data Even0 . . . Even3 (corresponding to data 0, 2, 4, 6 . . . ) are generated. The signals DFE1 and DFE3 are sampled by the sampling clock DFECLKN, and thereby odd-bit data Odd0 . . . Odd3 (corresponding to data 1, 3, 5, 7 . . . ) are generated.

The first-order DFE is discussed in this paragraph. When DFE_EN=1′b1, DFE_TAP2=1′b0, and DFE_TAP1=1′b1, the first-order DFE is enabled, and the sampling circuit 106 samples and outputs the even-bit data Even0 and Even1, and the odd-bit data Odd0 and Odd1. The separated odd-bit channel and even-bit channel achieve half-rate serial-to-parallel conversion. The even-bit data (Even0 and Even1) are transferred through the even-bit channel, and the odd-bit data (Odd0 and Odd1) are transferred through the odd-bit channel.

When being switched to the second-order DFE, DFE_EN=1′b1, DFE_TAP2=1′b1, and DFE_TAP1=1′bx. The sampling circuit 106 samples and obtains the even-bit data Even0 . . . Even3 and the odd-bit data Odd0 . . . Odd3. Through the proposed half-rate serial-to-parallel conversion, the even-bit data (Even0 . . . Even3) and the odd-bit data (Odd0 . . . Odd3) are separated to the even-bit channel and odd-bit channel.

The even-bit data and the odd-digit data are sent to the adder circuit with parallel-to-serial conversion 108 for processing.

In addition to receiving the sampling clocks DFECLKP and DFECLKN, the adder circuit with parallel-to-serial conversion 108 further receives the even-bit data Even0 . . . Even3, the odd-bit data Odd0 . . . Odd3, the selection signals Sel_even1 and Sel_even2 of the even-bit channel, and the selection signals Sel_odd1 and Sel_odd2 of the odd-bit channel. In addition to organizing the received data, the adder circuit with parallel-to-serial conversion 108 further implements parallel-to-serial conversion (combining two signals into one signal), and buffers the sampling clocks DFECLKP and DFECLKN. The signals output from the adder circuit with parallel-to-serial conversion 108 include the even-bit half-rate data EVENOUT, the odd-bit half-rate data ODDOUT, the full-rate data ZI, and sampling clocks CKOP and CKON. The sampling clock CKOP corresponds to the even-bit half-rate data EVENOUT. The sampling clock CKON corresponds to the odd-bit half-rate data ODDOUT.

Based on the four input signals DFE_EN, DFECLKP, DFECLKN, and R2RTURNAROUND, the initialization circuit 102 generates selection signals Initevent1, Initevent2, and Initoddt2 for selecting the first bit on the even-bit channel and the first bit on the odd-bit channel, to correspond to the different circuit events (such as a power-on event, an enable signal switching event, or a read-to-read turn around event).

The selection circuit 104 performs logical calculations on the input signals, to generate the selection signals (Sel_even1, Sel_even2) for the even-bit channel and the selection signals (Sel_odd1, Sel_odd2) for the odd-bit channel. The first-order DFE works based on the selection signals Sel_even1 and Sel_odd1. The second-order DFE works based on the selection signals Sel_even1, Sel_even2, Sel_odd1 and Sel_odd2.

The sampling circuit 106 performs sampling for the even-bit channel according to the sampling clock DFECLKP, and performs sampling for the odd-bit channel according to the sampling clock DFECLKN. The sampling circuit 106 further takes the signals DFE_TAP1 and DFE_TAP2 into consideration when sampling signals for the different channels. The sampling circuit 106 separates the even-bit data and odd-bit data to the even-bit channel and the odd-bit channel, respectively.

The data collected by the sampling circuit 106 is sent to the adder circuit with parallel-to-serial conversion 108, which operates according to selection signals from the selection circuit 104 and the sampling clocks DFECLKP and DFECLKN. The adder circuit with parallel-to-serial conversion 108 converts the sampled data to the half-rate data EVENOUT and ODDOUT, and combines the half-rate data EVENOUT and ODDOUT to generate the full-rate data ZI.

The sampling circuit 106 collects and transfers the even-bit data and the odd-bit data separately through the even-bit channel and the odd-bit channel, to be separately received by the adder circuit with parallel-to-serial conversion 108 for logic calculations. Therefore, half-rate data acquisition is achieved. The limitation for path timing of the receiving circuit is increased from 1UI to 2UI.

In the sampling circuit 106, the sampling for the even-bit channel is performed based on the sampling clock DFECLKP, and the sampling for the odd-bit channel is performed based on the sampling clock DFECLKN. The signals DFE_TAP1 and DFE_TAP2 are a first-order DFE enable signal and a second-order DFE enable signal, respectively. Depending on the signals DFE_TAP1 and DFE_TAP2, which paths output the sampled data are determined.

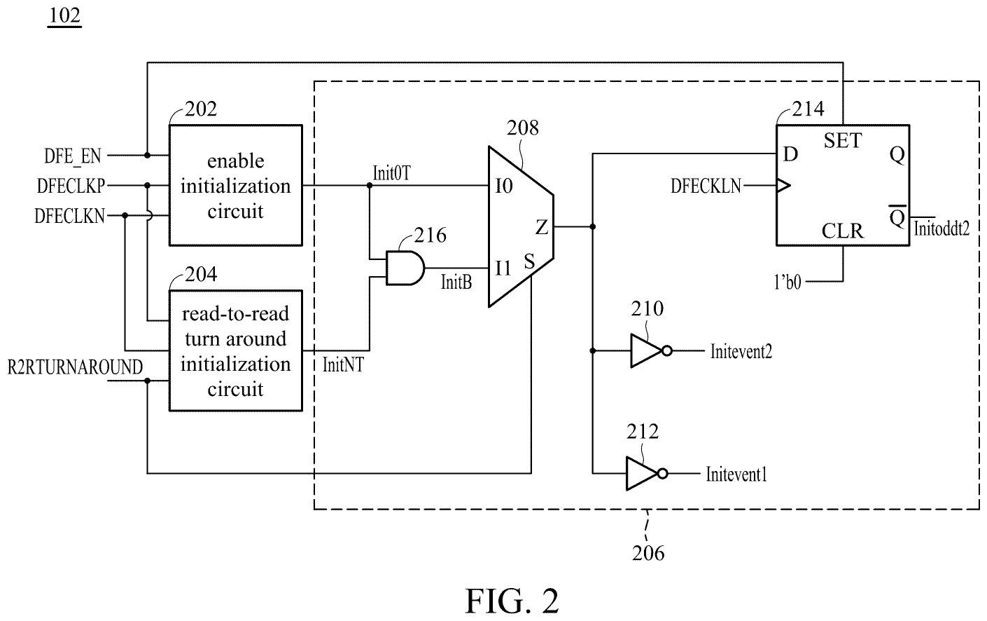

FIG. 2 is a block diagram illustrating the functional blocks in the initialization circuit 102 in accordance with an exemplary embodiment of the disclosure, which includes an enable initialization circuit 202, a read-to-read turn around initialization circuit 204, and a logic circuit 206.

Taking DDR5 as an example, the initialization circuit 102 has two working states.

In the first working state, the circuit is powered on, or the signal DFE_EN switches from 1′b0 to 1′b1. During one round of reading, the signal R2RTRUNAROUND is 1′b0, the enable initialization circuit 202 outputs a zero pulse Init0T with 1T width. Through the multiplexer 208, the pulse signal Init0T is sent to the inverter 210 to generate the signal Initevent2, and is also sent to the inverter 212 to generate the signal Initevent1. The signals Initevent2 and Initevent1 are used in the selection of the first bit data (data0) of the even-bit channel (applied to the first-order DFE and the second-order DFE both). The D flip-flop 214 samples the signal Init0T according to the sampling clock DFECLKN. After 1UI delay and signal inversion, the D flip-flop 214 outputs the signal Initoddt2 via the Q̅ terminal. The signal Initoddt2 is used in the selection of the first bit data (data1) of the odd-bit channel (applied to only the second-order DFE).

In the second working state after the power-on event, the signal DFE_EN is 1′b1. At this time, the enable initialization circuit 202 keeps the signal Inti0T at 1. If there is a read-to-read turn around event, the logic controller makes the signal R2RTRUNAROUND being a pulse with a length of N clock cycles (NT, where 6<N<12). In response to the pulse of the signal R2RTRUNAROUND, the intermediate signal InitNT generated by the read-to-read turn around initialization circuit 204 is a pulse of zero in a first cycle defined according to the sampling clock DFECLKP, wherein the pulse width is one clock cycle. The intermediate signals InitNT and the signal Init0T are processed by an AND gate 216 to generate another intermediate signal InitB. Through the multiplexer 208, the intermediate signal InitB is sent to the inverter 210 for inversion, and the signal Initevent2 is generated. The intermediate signal InitB is also sent to the inverter 212 for inversion, and the signal Initevent1 is generated. The signals Initevent2 and Initevent1 are applied to the selection of the first bit data (data0) of the even-bit channel (applied to the first-order DFE and the second-order DFE both). The D flip-flop 214 samples the intermediate signal InitB according to the sampling clock DFECLKN. After 1UI delay and signal inversion, the D flip-flop 214 outputs the signal Initoddt2 at the Q̅ terminal. The signal Initoddt2 is applied to the selection of the first bit data (data1) of the odd-bit channel (applied to only the second-order DFE).

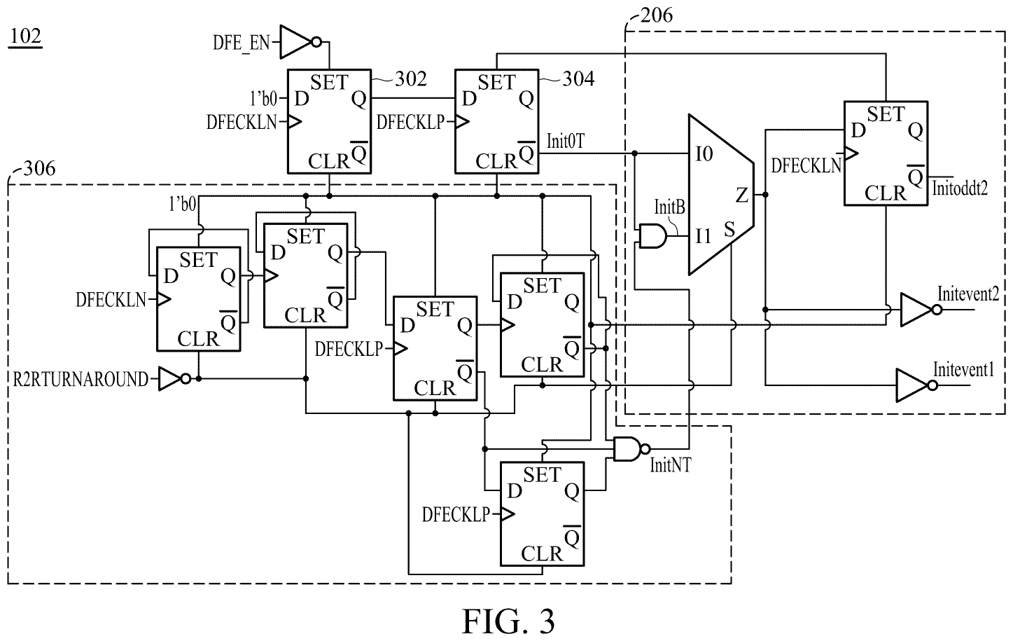

FIG. 3 illustrates the details of the initialization circuit 102 in accordance with an exemplary embodiment of the disclosure, which uses two D flip-flops 302 and 304 to form the enable initialization circuit 202, and uses an asynchronous counter 306 to implement the read-to-read turn around initialization circuit 204. The logic circuit 206 implements the selection function, which operates in response to the power-on event, the enable event, and the read-to-read turn around event, to generate first bit selection signals Initevent1, Initevent2, and Initoddt2 for generating the first bit to the even-bit channel and the first bit to the odd-bit channel.

As shown in FIG. 3, the D flip-flop 302 operating according to the sampling clock DFECLKN receives the signal 1′b0 via a D input terminal. The D flip-flop 304 operating according to the sampling clock DFECLKP uses a D input terminal to receive the Q output of the D flip-flop 302, and outputs the intermediate signal Init0T via a Q̅ terminal. The asynchronous counter 306 generates the intermediate signal InitNT based on the read-to-read turn around signal R2RTRUNAROUND and the sampling clocks DFECLKP and DFECLKN. The logic circuit 206 generates the first bit selection signals (Initevent1, Initevent2, and Initoddt2) for the even-bit channel and the odd-bit channel based on the intermediate signals Init0T and InitNT, and the sampling clock DFECLKN.

In FIG. 3, the logic circuit 206 uses an AND gate which receives the intermediate signals Init0T and InitNT to generate the intermediate signals InitB. The logic circuit 206 further has a multiplexer and a D flip-flop. As controlled by the read-to-read turn around signal R2RTRUNAROUND, the multiplexer receives the intermediate signals Init0T and InitB to output a signal to the D input terminal of the D flip-flop. Accordingly, the D flip-flop outputs the signal Initoddt2 via the Q terminal. The logic circuit 206 further includes two inverters, each inverting the output of the multiplexer, to generate the signals Initevent1 and Initevent2.

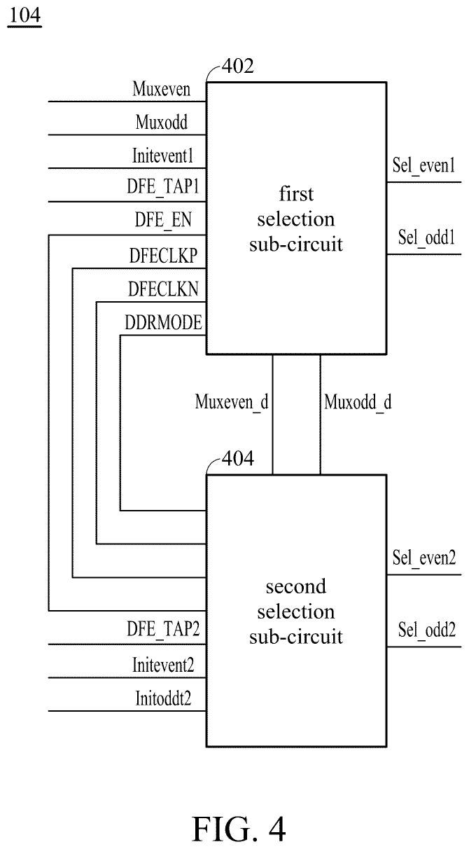

FIG. 4 is a block diagram illustrating the functional blocks of the selection circuit 104 in accordance with an exemplary embodiment of the disclosure, which includes a first selection sub-circuit 402 and a second selection sub-circuit 404. The first selection sub-circuit 402 works for the first-order DFE, and includes a DDR mode selection function controlled through the signal DDRMODE. The second selection sub-circuit 404 works for the second-order DFE, and also includes a DDR mode selection function that is controlled through the signal DDRMODE.

The DDR mode (selected through DDRMODE) may be a DDR5 mode or an LPDDR5 mode. The receiver (RX) of DDR usually has an on-die termination (ODT) design. The ODT of DDR5 is coupled to the power supply, so that the previous bit before the valid bits is usually high. The ODT of LPDDR5 is coupled to the ground, so that the previous bit before the valid bits is usually low.

The signal DDR mode shows the DDR mode. When DDRMODE is 1′b1, it means DDR5 is used. When DDRMODE is 1′b0, it means LPDDR5 is used. In the DDR5 mode, the initialization circuit 102 recognizes the high ODT level, which is pulled up for one cycle. In the LPDDR5 mode, the initialization circuit 102 recognizes the low ODT level, which is pulled down for one cycle. Through the signals DFE_TAP1 and DFE_TAP2, the calculation order of DFE is selected based on data rate and the quality of the propagation channels. A calibration procedure may be introduced. Generally, the first-order DFE is applied to the circuit first. According to the calibration procedure, if the eye diagram meets the requirements, there is no need to switch to the second-order DFE, and the power consumption is limited. On the contrary, the second-order DFE starts, and the selection circuit 102 generates the selection signals Sel_even1, Sel_even2, Sel_odd1, and Sel_odd2 to control the adder circuit with the parallel-to-serial conversion 108, to select signals from Even0 . . . Even3, and Odd0 . . . Odd3, and to output the selected signals to the even-bit channel or the odd-bit channel.

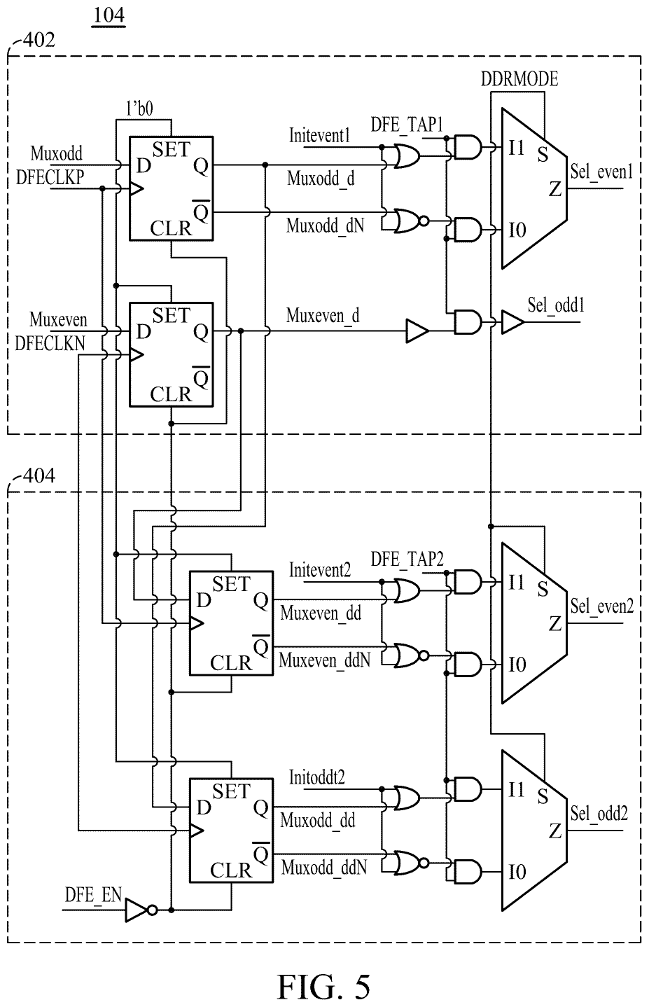

FIG. 5 illustrates the details of the selection circuit 104 in accordance with an exemplary embodiment of the disclosure. The following takes the second-order DFE in the DDR5 mode as an example, to illustrate how the selection circuit 104 generates the selection signals.

Referring to the first selection sub-circuit 402, the first selection sub-circuit 402 processes the signals Muxeven and Muxodd received from the adder circuit with parallel-to-serial conversion 108. A signal Muxodd_d is obtained by sampling the signal Muxodd according to the sampling clock DFECLKP. The signal Muxodd_d is added to the signal initevent1, and then is multiplied with the signals DFE_TAP1 and DDRMODE, to generate the selection signal Sel_even1 for the even-bit channel. A signal Muxeven_d is obtained by sampling the signal Muxeven according to the sampling clock DFECLKN. The signal Muxeven is delayed and then multiplied by the signal DFE_TAP1, to generate the selection signal Sel_odd1 for the odd-bit channel.

Referring to the second selection sub-circuit 404, the second selection sub-circuit 404 processes the signals Muxeven_d and Muxodd_d received from the first selection sub-circuit 402. The signal Muxeven_d is sampled by the sampling clock DFECLKP to generate the signal Muxeven_dd. The signal Muxeven_dd is added to the signal initevent2, and then multiplied by the signals DFE_TAP2 and DDRMODE, to generate the selection signal Sel_even2 for the even-bit channel. The signal Muxodd_d is sampled by the sampling clock DFECLKN to generate a signal Muxodd_dd. The signal Muxodd_dd is added to the signal initoddt2, and then multiplied by the signals DFE_TAP2 and DDRMODE, to generate the selection signal Sel_odd2 for the odd-bit channel.

To summarize, based on the previous odd-bit data (obtained from the signal Muxodd fed back from the adder circuit with parallel-to-serial conversion 108), the selection circuit 104 generates the selection signals Sel_even1 and Sel_even2 to control the adder circuit with parallel-to-serial conversion 108, wherein the selection signal Sel_even1 is for the operations of the first-order DFE, and the selection signals [Sel_even2, Sel_even1] are for the operations of the second-order DFE. Similarly, based on the previous even-bit data (obtained from the signal Muxeven fed back from the adder circuit with parallel-to-serial conversion 108), the selection circuit 104 generates the selection signals Sel_odd1 and Sel_odd2 to control the adder circuit with parallel-to-serial conversion 108, wherein the selection signal Sel_odd1 is for the operations of the first-order DFE, and the selection signals [Sel_odd2, Sel_odd1] are for the operations of the second-order DFE.

Regarding the even-bit channel selection signals [Sel_even2, Sel_even1], or the odd-bit channel selection signals [Sel_odd2, Sel_odd1], their different combinations may cause the adder circuit with parallel-to-serial conversion 108 to perform the different actions:

$$when taking 2 ’ b 00 , Muxeven = Even 0 , or Muxodd = Odd 0 ;$$

$$when taking 2 ’ b 01 , Muxeven = Even 1 , or Muxodd = Odd 1 ;$$

$$when taking 2 ’ b 10 , Muxeven = Even 2 , or Muxodd = Odd 2 ;$$

$$when taking 2 ’ b 11 , Muxeven = Even 3 , or Muxodd = Odd 3.$$

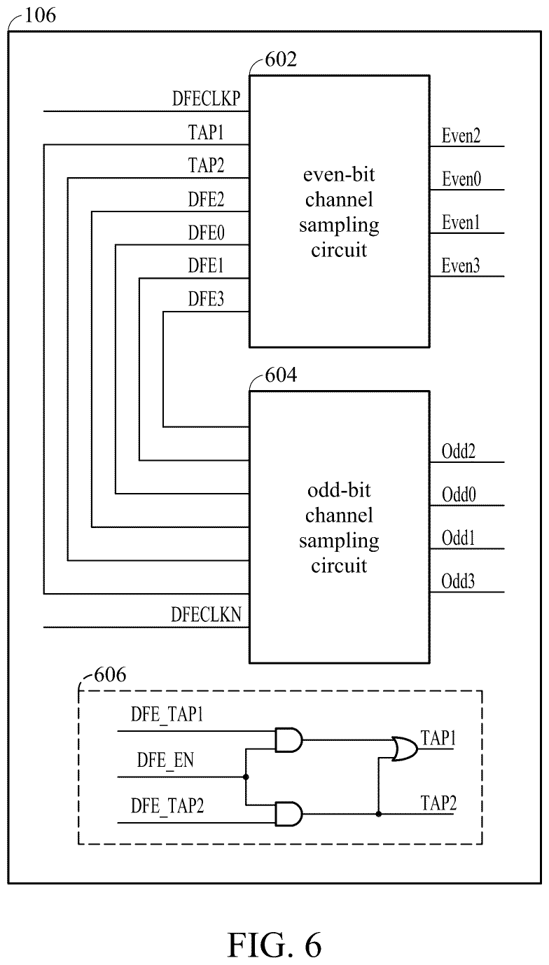

FIG. 6 is a block diagram, illustrating the functional blocks of the sampling circuit 106 in accordance with an exemplary embodiment of the disclosure, which includes an even-bit channel sampling circuit 602, an odd-bit channel sampling circuit 604, and a logic circuit 606, and implements serial-to-parallel conversion for generation of half-rate data.

The even-bit channel sampling circuit 602 samples the even-bit data (i.e., data0, data2, data4 . . . ) according to the sampling clock DFECLKP. The odd-bit channel sampling circuit 604 samples odd-bit data (i.e., data1, data3, data5 . . . ) according to the sampling clock DFECLKN. The logic circuit 606 controls how to output the sampled data. When the signal TAP1 is valid, the sampling circuit 106 only outputs the even-bit data Even0 and Even1, and the odd-bit data Odd0 and Odd1. When the signal TAP2 is valid, the sampling circuit 106 outputs all even-bit data Even0 . . . Even3 and all odd-bit data Odd0 . . . Odd3.

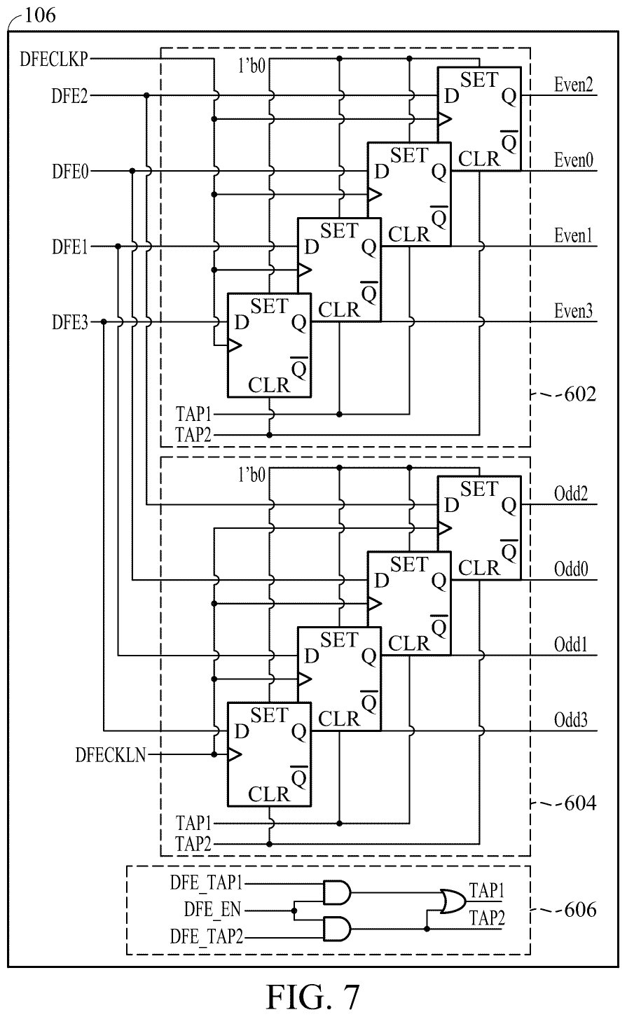

FIG. 7 illustrates the details of the sampling circuit 106 in accordance with an exemplary embodiment of the disclosure. In addition to the logic circuit 606 that generates the signals TAP1 and TAP2, the sampling circuit 106 illustrated in FIG. 7 shows eight D flip-flops.

The even-bit channel sampling circuit 602 includes four D flip-flops operated according to the sampling clock DFECLKP, which receive the sampling objects DFE0 . . . DFE3, respectively, to generate even-bit data Even0 . . . Even3. In the even-bit channel sampling circuit 602, two D flip-flops receive the first-order DFE enable signal TAP1 as the clear input, and the other two D flip-flops receive the second-order DFE enable signal TAP2 as the clear input. In the similar structure, the odd-bit channel sampling circuit 604 includes four D flip-flops operated according to the sampling clock DFECLKN, which receive the sampling objects DFE0 . . . DFE3, respectively, to generate odd-bit data Odd0 . . . Odd3. In the odd-bit channel sampling circuit 604, two D flip-flops receive the first-order DFE enable signal TAP1 as the clear input, and the other two D flip-flops receive the second-order DFE enable signal TAP2 as the clear input.

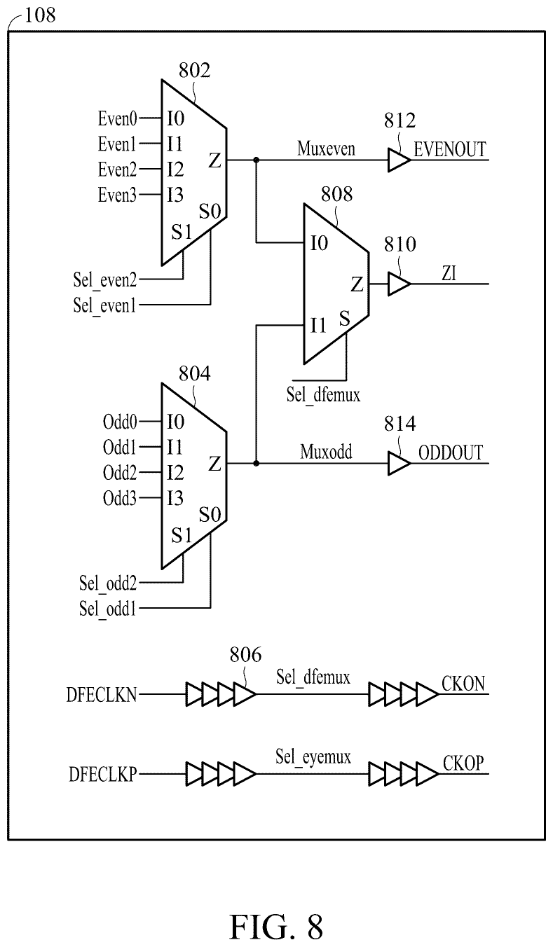

FIG. 8 illustrates the details of the adder circuit with parallel-to-serial conversion 108 in accordance with an exemplary embodiment of the disclosure.

When the first-order DFE is enabled, the selection signals Sel_even2 and Sel_odd2 are 0. If the previous bit is 0, the multiplexers 802 and 804 output data Even0 and Odd0, respectively. If the previous bit is 1, the multiplexers 802 and 804 output data Even1 and Odd1, respectively.

When the second-order DFE is enabled, the control of multiplexers 802 and 804 is based on the previous two bits. The even-bit channel operates based on the selection signals [Sel_even2, Sel_even1]. The odd-bit channel operates based on the selection signals [Sel_odd2, Sel_odd1]. When the selection signals are 2′b00, the multiplexers 802 and 804 output data Even0 and Odd0, respectively. When the selection signals are 2′b01, the multiplexers 802 and 804 output data Even1 and Odd1, respectively. When the value is 2′b10, the multiplexers 802 and 804 output signals Even2 and Odd2 respectively. When the selection signals are is 2′b11, the multiplexers 802 and 804 output data Even3 and Odd3 respectively.

The sampling clock DFECLKN is delayed by at least 1UI through the delay circuit 806, to form a signal Sel_dfemux. As controlled by the signal Sel_dfemux, the multiplexer 808 outputs the signal Muxeven (named an even-bit multiplexer output) or the signal Muxodd (named an odd-bit multiplexer output) to realize the parallel to serial conversion (two to one). Then, full-rate data ZI is generated by passing through the buffer 810. Through the buffer 812, the signal Muxeven may be output as the half-rate output EVENOUT. By passing through the buffer 814, the signal Muxodd may be output as the half-rate output ODDOUT. In addition, the sampling clocks DFECLKP and DFECLKN may be modified through the buffers to generate the sampling clocks CKOP and CKON.

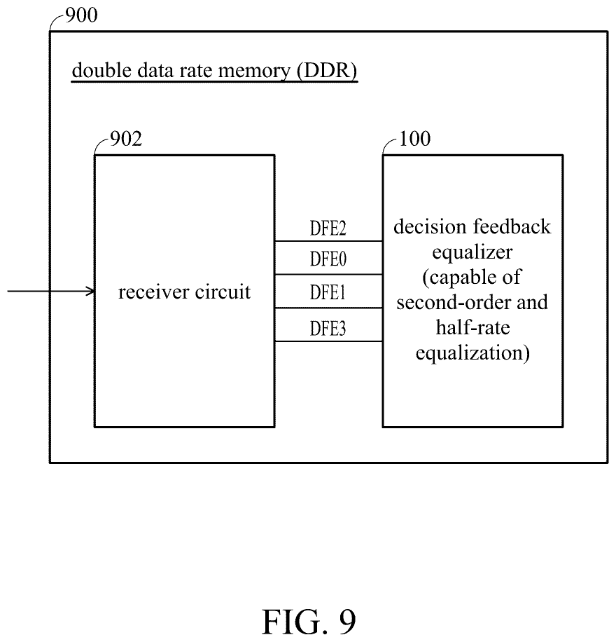

FIG. 9 is a block diagram illustrating a double data rate memory (DDR) 900 in accordance with an exemplary embodiment of the disclosure, which uses a receiver circuit 902 to receive a signal and generate the signals DFE0-DFE3 to be processed by the DFE 100. Any electronic device with the DDR that includes the DFE 100 capable of second-order and half-rate equalization falls within the scope of the disclosure.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A decision feedback equalizer for a double data rate memory, comprising:
a sampling circuit, separating the sampling of a sampling object into even bits and odd bits, to output even-bit data on an even-bit channel, and to output odd-bit data on an odd-bit channel; and;
an adder circuit with parallel-to-serial conversion, coupled to the sampling circuit to receive the even-bit data and the odd-bit data, and to combine the even-bit data with the odd-bit data to generate full-rate data.

2. The decision feedback equalizer as claimed in claim 1, wherein:
the sampling circuit uses a first sampling clock and a second sampling clock to implement rising-edge and falling-edge sampling, and thereby the even-bit data and the odd-bit data are obtained.

3. The decision feedback equalizer as claimed in claim 2, wherein:
the adder circuit with parallel-to-serial conversion organizes the even-bit data to generate even-bit half-rate data; and
the adder circuit with parallel-to-serial conversion organizes the odd-bit data to generate odd-bit half-rate data.

4. The decision feedback equalizer as claimed in claim 3, wherein:
the adder circuit with parallel-to-serial conversion further modifies the first sampling clock as a third sampling clock that corresponds to the even-bit half-rate data; and
the adder circuit with parallel-to-serial conversion further modifies the second sampling clock as a fourth sampling clock that corresponds to the odd-bit half-rate data.

5. The decision feedback equalizer as claimed in claim 3, wherein:
multiple sampling objects are received by the sampling circuit, which are contents that the double data rate memory receives and identifies based on different reference values; and
multiple even-bit data and multiple odd-bit data that correspond to the multiple sampling objects are obtained by the sampling circuit.

6. The decision feedback equalizer as claimed in claim 5, further comprising:
a selection circuit, generating selection signals to control multiplexers in the adder circuit with parallel-to-serial conversion to organize the multiple even-bit data and the multiple odd-bit data to sort out the even-bit half-rate data and the odd-bit half-rate data, and form the full-rate data.

7. The decision feedback equalizer as claimed in claim 6, wherein:
the selection circuit generates even-bit channel selection signals based on previous odd-bit data, to control the adder circuit with parallel-to-serial conversion; and
the selection circuit generates odd-bit channel selection signals based on previous even-bit data, to control the adder circuit with parallel-to-serial conversion.

8. The decision feedback equalizer as claimed in claim 7, wherein:
based on the even-bit channel selection signals, the adder circuit with parallel-to-serial conversion makes a selection between the different even-bit data to generate an even-bit channel multiplexer output;
based on the odd-bit channel selection signals, the adder circuit with parallel-to-serial conversion makes a selection between the different odd-bit data to generate an odd-bit channel multiplexer output; and
based on the even-bit channel multiplexer output and the odd-bit channel multiplexer output, the adder circuit with parallel-to-serial conversion sorts out the even-bit half-rate data and the odd-bit half-rate data, and combines the even-bit half-rate data and the odd-bit half-rate data to form the full-rate data.

9. The decision feedback equalizer as claimed in claim 8, wherein:
the adder circuit with parallel-to-serial conversion provides the odd-bit channel multiplexer output to the selection circuit as the previous odd-bit data; and
the adder circuit with parallel-to-serial conversion provides the even-bit channel multiplexer output to the selection circuit as the previous even-bit data.

10. The decision feedback equalizer as claimed in claim 9, performing first-order decision feedback equalization (DFE) by default to identify a current bit based on one previous bit, wherein
in response the first-order DFE not satisfying eye diagram requirements, the decision feedback equalizer performs second-order DFE to identify the current bit based on two previous bits.

11. The decision feedback equalizer as claimed in claim 10, wherein:
the sampling circuit receives four sampling objects and generates four even-bit data and four odd-bit data.

12. The decision feedback equalizer as claimed in claim 11, wherein the sampling circuit includes:
four D flip-flops for the even-bit channel, receiving the four sampling objects separately, to generate the four even-bit data, wherein two D flip-flops receive a first-order DFE enable signal as a clear input, and the other two D flip-flops receive a second-order DFE enable signal as a clear input; and
four D flip-flops for the odd-bit channel, receiving the four sampling objects separately, to generate the four odd-bit data, wherein two D flip-flops receive the first-order DFE enable signal as a clear input, and the other two D flip-flops receive the second-order DFE enable signal as a clear input.

13. The decision feedback equalizer as claimed in claim 11, wherein:
corresponding to the first-order DFE, the selection circuit provides a first even-bit channel selection signal to the adder circuit with parallel-to-serial conversion, to make a selection between number 0 even-bit data and number 1 even-bit data to generate the even-bit multiplexer output;
corresponding to the first-order DFE, the selection circuit further provides a first odd-bit channel selection signal to the adder circuit with parallel-to-serial conversion, to make a selection between number 0 odd-bit data and number 1 odd-bit data to generate the odd-bit multiplexer output;
corresponding to the second-order DFE, the selection circuit provides the first even-bit channel selection signal as well as a second even-bit channel selection signal to the adder circuit with parallel-to-serial conversion, to make a selection between number 0 even-bit data, number 1 even-bit data, number 2 even-bit data, and number 3 even-bit data to generate the even-bit multiplexer output; and
corresponding to the second-order DFE, the selection circuit provides the first odd-bit channel selection signal as well as a second odd-bit channel selection signal to the adder circuit with parallel-to-serial conversion, to make a selection between number 0 odd-bit data, number 1 odd-bit data, number 2 odd-bit data, and number 3 odd-bit data to generate the odd-bit multiplexer output.

14. The decision feedback equalizer as claimed in claim 13, wherein the adder circuit with parallel-to-serial conversion comprises:
a first multiplexer, receiving the number 0 even-bit data, number 1 even-bit data, number 2 even-bit data, and number 3 even-bit data, and controlled by the first even-bit channel selection signal and the second even-bit channel selection signal to generate the even-bit multiplexer output;
a second multiplexer, receiving the number 0 odd-bit data, number 1 odd-bit data, number 2 odd-bit data, and number 3 odd-bit data, and controlled by the first odd-bit channel selection signal and the second odd-bit channel selection signal, to generate the odd-bit multiplexer output; and
a third multiplexer, receiving the even-bit multiplexer output and the odd-bit multiplexer output to form the full-rate data.

15. The decision feedback equalizer as claimed in claim 9, wherein:
the selection circuit further operates according to a mode selection signal;
when the mode selection signal shows a first value representing a first-type double data rate memory, the even-bit channel selection signals and the odd-bit channel selection signals generated by the selection circuit comply with a condition that an on-die terminal of the first-type double data rate memory be coupled to a power supply; and
when the mode selection signal shows a second value representing a second-type double data rate memory, the even-bit channel selection signals and the odd-bit channel selection signals generated by the selection circuit comply with a condition that an on-die terminal of the second-type double data rate memory be coupled to ground.

16. The decision feedback equalizer as claimed in claim 13, wherein the selection circuit further comprises:
a first selection sub-circuit, generating the first even-bit channel selection signal and the first odd-bit channel selection signal to operate the adder circuit with parallel-to-serial conversion based on the odd-bit multiplexer output, the even-bit multiplexer output, a first-order DFE enable signal, and a mode selection signal.

17. The decision feedback equalizer as claimed in claim 16, wherein the selection circuit further comprises:
a second selection sub-circuit, generating the second even-bit channel selection signal and the second odd-bit channel selection signal to operate the adder circuit with parallel-to-serial conversion based on the odd-bit multiplexer output, the even-bit multiplexer output, a second-order DFE enable signal, and the mode selection signal.

18. The decision feedback equalizer as claimed in claim 9, further comprising:
an initialization circuit, generating first-bit selection signals for the even-bit channel and the odd-bit channel in response to a power-on event, an enable event, and a read-to-read turn around event, wherein
the first-bit selection signals are provided to the selection circuit to generate the even-bit channel selection signals and the odd-bit channel selection signals.

19. The decision feedback equalizer as claimed in claim 18, further comprising:
a first D flip-flop, operating according to the second sampling clock with a D input terminal receiving 1′b0;
a second D flip-flop, operating according to the first sampling clock with a D input terminal receiving a Q output from the first D flip-flop, and having an inverted Q terminal outputting a first intermediate signal;
an asynchronous counter, generating a second intermediate signal based on a read-to-read turn around signal, the first sampling clock, and the second sampling clock; and
a logic circuit, generating the first-bit selection signals for the even-bit channel and the odd-bit channel based on the first intermediate signal, the second intermediate signal, and the second sampling clock, wherein the first-bit selection signals are provided to the selection circuit to generate the even-bit channel selection signals and the odd-bit channel selection signals.

20. The decision feedback equalizer as claimed in claim 19, wherein the logic circuit comprises:
an AND gate, receiving the first intermediate signal and the second intermediate signal to generate a third intermediate signal;
a multiplexer and a third D flip-flop, wherein the multiplexer receives the first intermediate signal and the third intermediate signal, and is controlled by an inversed signal of the read-to-read turn around signal to generate a multiplexer output to be sent to a D input for the third D flip-flop, so that the third D flip-flop outputs an inverted Q signal as one signal of the first-bit selection signals; and
two inverters, each inverting the multiplexer output to generate two signals of the first-bit selection signals.
